(19) United States
(12) Patent Application Publication
(10) Pub. No.: US 2024/0051802 A1
(43) Pub. Date: Feb. 15, 2024

(54) OPTIMIZED TENSION PICKUP AUTOMATION FOR WIRELINE AND COILED TUBING

(71) Applicant: Schlumberger Technology Corporation, Sugar Land, TX (US)

(72) Inventors: Muhannad Abuhaikal, Cambridge, MA (US); Hisayo Tauchi, Sugar Land, TX (US)

(21) Appl. No.: 18/363,194

(22) Filed: Aug. 1, 2023

Related U.S. Application Data
(60) Provisional application No. 63/370,978, filed on Aug. 10, 2022.

(51) Int. Cl. B66D 1/50; G01L 5/04; E21B 19/00; E21B 19/084

(52) U.S. Cl. CPC B66D 1/505; G01L 5/04; E21B 19/008; E21B 19/084

(57) ABSTRACT

Systems and methods are disclosed herein for improved wireline tension measurement and calibration in an oil-and-gas setting. An example method can include providing a machine-learning model configured to receive inputs associated with wireline tension. The inputs can include, for example, well-trajectory information, fluid density, fluid viscosity, toolstring type, cable type, and friction coefficient. The method can include providing some or all of those inputs and receiving an output from the machine-learning model of an estimated wireline tension. The method can also include receiving a second output of a wireline location recommended for measurement. A user can then perform a measurement at the suggested location and provide the measurement as an additional input to the machine-learning model.

### CROSS REFERENCE

This application claims priority to provisional application No. 63/370,978, titled “Wireline Tension Measurement Calibration,” filed on Aug. 10, 2022, the contents of which are incorporated by reference.

### BACKGROUND

The present disclosure is related in general to calibrating tension of a cable, or wireline, such as that used with wellbore equipment including oilfield equipment, downhole assemblies, and the like.

In some oilfield and hydrocarbon related operations, tools can be advanced into a wellbore on a wireline cable to perform various operations, such as drilling, milling, machining, and cutting, to name just a few examples. Tension on the wireline cable is a critical component in this operations. For example, cable tension can be used to pull out stuck objects or apply force, such as when using a jarring tool. Excessive cable tension can cause the cable to break, leaving any connected tools in the wellbore and requiring time-consuming retrieval techniques.

Because cable tension is critical, field operators typically measure cable tension in an operation referred to as tension pickup. A typical tension pickup operation includes a user pulling up on the toolstring while the tool is moving downhole, such as by operating a winch that can wind or unwind the cable. The user pulls the toolstring up a certain distance at a constant speed. Meanwhile, one or more sensors associated with the wireline measure surface tension. The sensors can be associated with the winch, such as by being integrated into a wireline truck that includes a built-in winch.

The tension measurements can then be compared to an estimated tension, which is typically calculated based on an estimated friction coefficient within the hole and perhaps other measurements as well. Based on the actual measurements, the estimated friction coefficient can be calibrated to match the measurements. Typically, this tension pickup operation is performed every 2000 feet at a speed of approximately 1000 feet/hour, although other intervals and measurement speeds may be used.

The typical tension pickup operations described above are not optimized. Instead, they occur at a regular interval and speed, sometimes resulting in unnecessary tension pickups, while other times resulting in fewer tension pickups than necessary. In addition, the typical pickup operations are not “smart” in that there is no learning or optimizing over time. Instead, the typically tension pickup operations simply measure the tension in a regular fashion and, at best, result in a modified estimated friction coefficient. This lack of optimization and learning results in wasted resources that could otherwise be put to productive work.

As a result, a need exists for new and improved methods of wireline tension measurement and calibration.

It is against this backdrop that the disclosed embodiments are described herein.

### SUMMARY

Systems and methods are disclosed herein for improved wireline tension measurement and calibration in an oil-and-gas setting. An example method can include providing a machine-learning model configured to receive inputs associated with wireline tension. The inputs can include, for example, well-trajectory information, fluid density, fluid viscosity, toolstring type, cable type, and friction coefficient. The method can include providing some or all of those inputs and receiving an output from the machine-learning model of an estimated wireline tension. The method can also include receiving a second output of a wireline location recommended for measurement.

A user can then perform a measurement at the suggested location and provide the measurement as an additional input to the machine-learning model. As a result of providing the measurement as the additional input, the machine-learning model provides updated outputs, such as by providing an updated estimated wireline tension and an updated location recommended for measurement. The machine-learning model can also include a recommended cable speed for the measurement. It can further include an interval between multiple wireline locations recommended for measurement. The method can also include receiving an updated friction coefficient from the model, which can be used for subsequent processing by the model.

The methods herein can be incorporated into a non-transitory, computer-readable medium. The medium can include instructions that, when executed by a hardware-based processor of a computing device, performs various stages as described in the example methods herein.

In addition, the methods herein can be performed by a system that includes, for example, a toolstring that includes a wireline, a winch configured to wind or unwind the wireline, a tension measurement sensor, and a control unit. The control unit can include a processor that executes instructions to perform the stages of the methods described herein.

This summary section is not intended to give a full description of the disclosed systems and methods.

### BRIEF DESCRIPTION OF THE DRAWINGS

The embodiments of the present invention are illustrated by way of example, and not by way of limitation, in the figures of the accompanying drawings and in which like reference numerals refer to similar elements. The disclosure is best understood from the following detailed description when read with the accompanying figures. It is emphasized that, in accordance with standard practice in the industry, various features are not drawn to scale. In fact, the dimensions of various features may be arbitrarily increased or reduced for clarity of discussion.

FIG. 1 is a side view of a well site where wireline tension measurement and calibration may be performed.

FIG. 2 is a flowchart of an example method for wireline tension measurement and calibration.

### DETAILED DESCRIPTION

It is to be understood that the following disclosure provides many different embodiments, or examples, for implementing different features of various embodiments. Specific examples of components and arrangements are described below to simplify the disclosure. These are, of course, merely examples and are not intended to be limiting. In addition, the disclosure may repeat reference numerals and/or letters in the various examples. This repetition is for the purpose of simplicity and clarity and does not in itself dictate a relationship between the various embodiments and/or configurations discussed. Moreover, the formation of a first feature over or on a second feature in the description that follows may include embodiments in which the first and second features are formed in direct contact and may also include embodiments in which additional features may be formed interposing the first and second features, such that the first and second features may not be in direct contact.

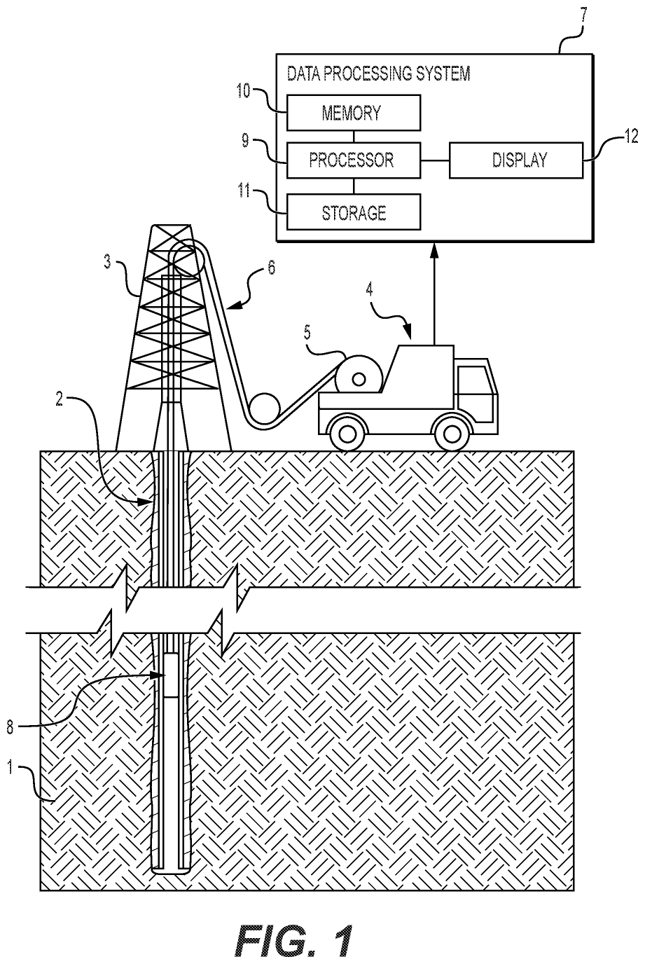

FIG. 1 shows an exemplary well site where wireline tension measurement and calibration may be performed. A formation 1 has a drilled and completed wellbore 2. A derrick 3 above ground may be used to raise and lower components into the wellbore 2 and otherwise assist with well operations.

A wireline surface system 4 at the ground level includes a wireline logging unit, a wireline depth control system 5 having a cable 6, and an electronic control system 7. The wireline surface system 4 can also include one or more sensors for measuring cable tension. The cable is connected to a connection assembly 8 that may be lowered downhole. The electronic control system 7 includes a processor 9, memory 10, storage 11, and display 12 that may be used to control various operations of the wireline surface system 4, send and receive data, and store data.

The connection assembly 8 includes equipment for mechanically and electronically connecting the tool with the cable 6. The cable 6 includes a support wire, such as steel, to mechanically support the weight of the slot cutting assembly and communication wire to pass communications between the tool and the wireline surface system 4. The tool can be installed below the connection assembly 8.

The wireline surface system 4 can deploy the cable 6, which in turn lowers the connection assembly 8 and tool deeper downhole. Conversely, the wireline surface system 4 can retract the cable 6 and raise the connection assembly 8 and tool, including to the surface. The cable 6 is deployed or retracted by the wireline depth control system 5, such as by unwinding or winding the cable 6 around a spool or winch that is driven by a motor.

The wireline logging unit communicates with the electronic control system 7 to send and receive data and control signals. For example, the wireline logging unit can communicate data received from the connection assembly 8 and tool to the electronic control system 7. The wireline logging unit likewise can communicate data and control signals received from the electronic control system 7 to the connection assembly 8 and slot cutting assembly.

In some examples, the electronic control system 7 can store a machine-learning model. The model can be trained at a remote server in some examples, such as by providing historical measurements associated with cable tension measurement as training inputs. The machine-learning model can continue to train itself and adapt as it receives new information and feedback, as described in more detail below.

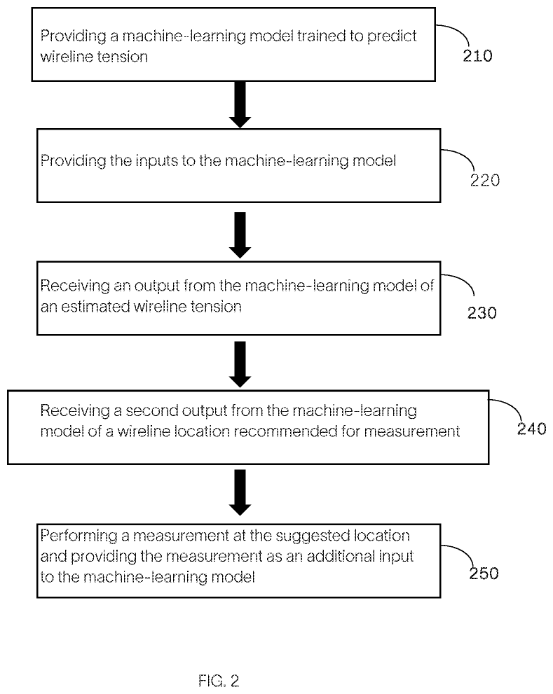

FIG. 2 provides a flowchart of an example method for wireline tension measurement and calibration. At stage 210 of the method, a machine-learning model can be provided. For example, the model can be transmitted from a remote server, where the model was trained, to the electronic control system 7 of FIG. 1. The machine-learning model can be trained using wireline tension inputs, which can include any inputs related to estimating or determining wireline tension. The training inputs can include, for example, well-trajectory information, fluid density, fluid viscosity, toolstring type, cable type, friction coefficient, and previous cable tension. These training inputs can be used to train the model before the model is transmitted to the control system 7.

Stage 220 of the method can include providing new inputs to the machine-learning model. In one example, this stage includes providing at least two of well-trajectory information, fluid density, fluid viscosity, toolstring type, cable type, friction coefficient, and previous cable tension. This stage differs from stage 210 in that the inputs provided are not training inputs, but rather inputs for use in the trained machine-learning model. Any combination of these inputs may be provided as input to the model.

Stage 330 of the example method can include receiving an output from the machine-learning model. In some examples, the output is an estimated wireline tension. A second output can be provided at stage 340, which can include a wireline location recommended for a cable-tension measurement. In other words, the machine-learning model can estimate the cable tension at a particular location along the cable and output information informing an operator as to which portion of the cable should be measured. This can result in saving time, as an operator need not stop the cable at regular intervals, but instead can wait until the model indicates that a tension pickup operation is recommended.

At stage 340, an operator can perform a cable-tension measurement at the suggested location. As part of this stage, the operator can supply the measurement as an additional input to the machine-learning model. In some examples, the measurement is used as feedback for the model, such that the model adjusts itself over time based on the real-world measurements taking place at the wellsite.

The preceding description has been presented with reference to present embodiments. Persons skilled in the art and technology to which this disclosure pertains will appreciate that alterations and changes in the described structures and methods of operation can be practiced without meaningfully departing from the principle, and scope of this invention. Accordingly, the foregoing description should not be read as pertaining only to the precise structures described and shown in the accompanying drawings, but rather should be read as consistent with and as support for the following claims.

What is claimed is:

1. A method for wireline tension measurement and calibration, comprising:
providing a machine-learning model configured to receive inputs associated with wireline tension;
providing the inputs to the machine-learning model, wherein the inputs include at least two of well-trajectory information, fluid density, fluid viscosity, toolstring type, cable type, and friction coefficient;
receiving an output from the machine-learning model, wherein the output is an estimated wireline tension; and
receiving a second output from the machine-learning model, wherein the second output is a wireline location recommended for measurement.

2. The method of claim 1, further comprising performing a measurement at the suggested location and providing the measurement as an additional input to the machine-learning model.

3. The method of claim 2, wherein, as a result of providing the measurement as the additional input, the machine-learning model provides updated first and second outputs.

4. The method of claim 1, wherein the second output further includes a recommended cable speed for the measurement.

5. The method of claim 1, wherein the second output further includes an interval between multiple wireline locations recommended for measurement.

6. The method of claim 1, further comprising receiving an updated friction coefficient from the machine-learning model.

7. The method of claim 6, wherein the updated friction coefficient is used for subsequent processing by the machine-learning model.

8. A system for wireline tension measurement and calibration, comprising:
a toolstring including a wireline;
a winch configured to wind or unwind the wireline;
a tension measurement sensor; and
a control unit,
wherein the control unit comprises a processor that executes instructions to perform stages comprising:
providing a machine-learning model configured to receive inputs associated with wireline tension;
providing the inputs to the machine-learning model, wherein the inputs include at least two of well-trajectory information, fluid density, fluid viscosity, toolstring type, cable type, and friction coefficient;
receiving an output from the machine-learning model, wherein the output is an estimated wireline tension; and
receiving a second output from the machine-learning model, wherein the second output is a wireline location recommended for measurement.

9. The system of claim 8, the stages further comprising performing a measurement at the suggested location and providing the measurement as an additional input to the machine-learning model.

10. The system of claim 9, wherein, as a result of providing the measurement as the additional input, the machine-learning model provides updated first and second outputs.

11. The system of claim 8, wherein the second output further includes a recommended cable speed for the measurement.

12. The system of claim 8, wherein the second output further includes an interval between multiple wireline locations recommended for measurement.

13. The system of claim 8, the stages further comprising receiving an updated friction coefficient from the machine-learning model.

14. The system of claim 13, wherein the updated friction coefficient is used for subsequent processing by the machine-learning model.

15. A non-transitory, computer-readable medium comprising instructions that, when executed by a processor of a control unit, carries out stages for wireline tension measurement and calibration, the stages comprising:
providing a machine-learning model configured to receive inputs associated with wireline tension;
providing the inputs to the machine-learning model, wherein the inputs include at least two of well-trajectory information, fluid density, fluid viscosity, toolstring type, cable type, and friction coefficient;
receiving an output from the machine-learning model, wherein the output is an estimated wireline tension; and
receiving a second output from the machine-learning model, wherein the second output is a wireline location recommended for measurement.

16. The non-transitory, computer-readable medium of claim 15, the stages further comprising performing a measurement at the suggested location and providing the measurement as an additional input to the machine-learning model.

17. The non-transitory, computer-readable medium of claim 16, wherein, as a result of providing the measurement as the additional input, the machine-learning model provides updated first and second outputs.

18. The non-transitory, computer-readable medium of claim 15, wherein the second output further includes a recommended cable speed for the measurement.

19. The non-transitory, computer-readable medium of claim 15, wherein the second output further includes an interval between multiple wireline locations recommended for measurement.

20. The non-transitory, computer-readable medium of claim 15, the stages further comprising receiving an updated friction coefficient from the machine-learning model.
